(19) United States
(12) Patent Application Publication
(10) Pub. No.: US 2023/0129408 A1
(43) Pub. Date: Apr. 27, 2023

(54) Aglet Whistle

(71) Applicant: John Carl Rasmussen, Pleasanton, CA (US)

(72) Inventor: John Carl Rasmussen, Pleasanton, CA (US)

(21) Appl. No.: 18/047,505

(22) Filed: Oct. 18, 2022

Related U.S. Application Data
(60) Provisional application No. 63/271,004, filed on Oct. 22, 2021.

(51) Int. Cl. A43C 9/04; G10K 5/00

(52) U.S. Cl. CPC A43C 9/04; G10K 5/00

(57) ABSTRACT

An aglet with an integrated whistle is presented. The aglet with an integrated whistle consists of a modified aglet body and a whistle block. The aglet body is modified with whistle components consisting of a whistle window and a whistle bore. The whistle block is installed within the whistle bore, along the mouthpiece end of the aglet body such that the whistle block is positioned and engaged to the whistle window to form a duct-style or fipple-style type whistle. The aglet body is then installed along any suitable clothes wear cord to serve as a wearable whistle accessory suited for signaling or animal calling.

### FIELD OF THE INVENTION

The present invention relates generally to clothing accessories. More specifically, the present invention is a device capable of attaching to the end of any standard string to act as both an aglet as well as a functional whistle.

### BACKGROUND OF THE INVENTION

Aglet is the name for the small piece of plastic, metal, or other material that is usually found on the end of shoelaces or the drawstring of a sweatshirt. Aglets prevent the fibers of string from unraveling at the ends. Aglets also make it easier for string to be threaded through things like eyelets, lugs, or other lacing guides. Threading a string with frayed ends can be difficult as only part of the string can be inserted through a hole while the frayed portions extend away from the rest of the string. While aglets prove a useful functionality through the items mentioned, the fact that aglets are so frequently used and carried by individuals wearing shoes or sweatshirts opens up the possibility for additional functions an aglet could perform. For example, aglets are likely worn on the majority of hiking boots and other outdoor footwear. One may decide to go hiking or running in wilderness and end up losing a sense of direction. Typically, one that enjoys hiking or running would prefer to travel light as hiking and running are more enjoyable when not feeling over encumbered. Without carrying many items, one may find oneself lost in the wilderness without a means of signaling for help or rescue. Should the hiker or runner have some means of signaling for help, one could make one's location known to others and be rescued.

It is an objective of the present invention to offer a solution to the issue mentioned. The present invention is an aglet that can be placed on any standard string and can also function as a loud whistle. The present invention attempts to provide one with a simple method for always having a whistle available in case of emergency, without the need to carry an individual whistle at all times.

### SUMMARY OF THE INVENTION

The present invention is an aglet with a functional whistle capable of being loud enough to signal for rescue if one is lost in the wilderness. The design of the present invention allows for the device to function both as an aglet for standard strings as well as a whistle.

### BRIEF DESCRIPTION OF THE DRAWINGS

FIG. 1 is a diagram view of the present invention installed along shoelaces.

FIG. 2 is a diagram view of the present invention installed along a pair of sweatshirt drawstrings.

FIG. 3 is a perspective view of the present invention installed along a cord.

FIG. 4 is a vertical cross-sectional perspective view of the present invention installed along the cord.

FIG. 5 is a perspective view of the present invention in accordance with another embodiment.

FIG. 6 is a vertical cross-sectional perspective view of the present invention in accordance with another embodiment.

FIG. 7 a perspective view of the present invention in accordance with another embodiment.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

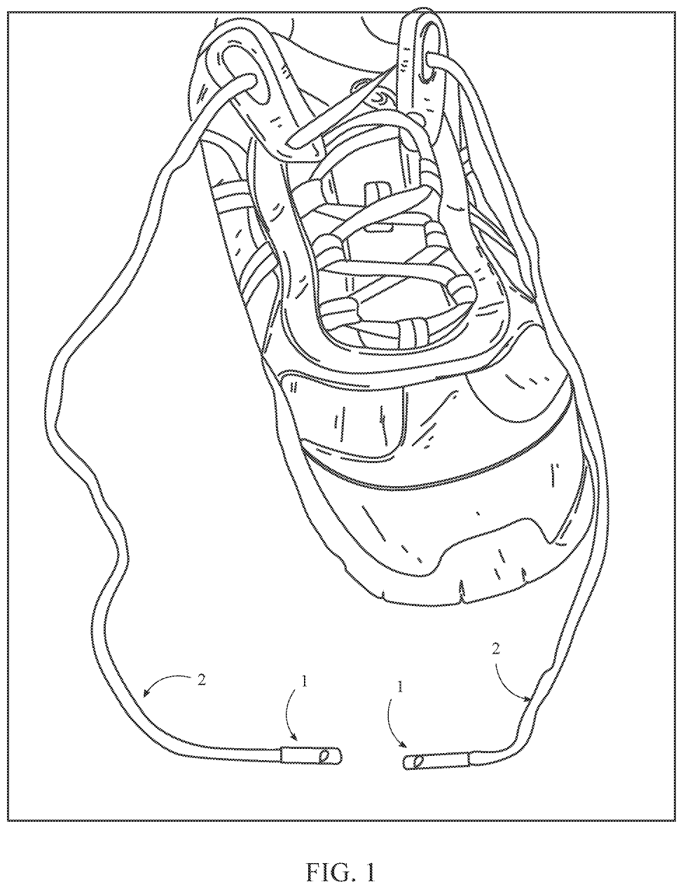

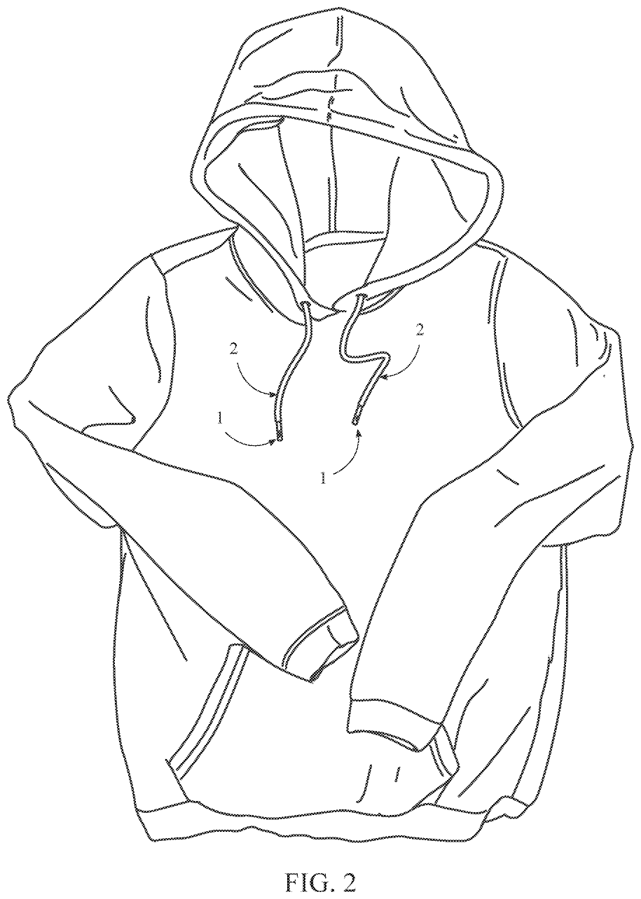

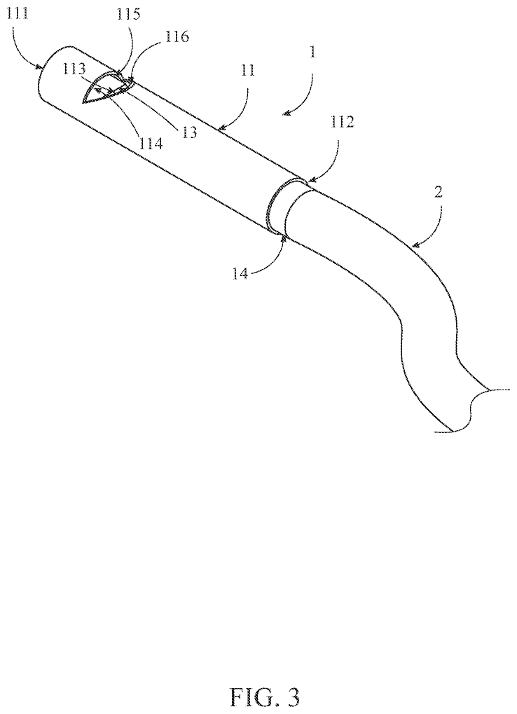

In reference to FIGS. 1-7, the present invention is an aglet with an integrated whistle 1. In the preferred embodiment, the aglet with an integrated whistle 1 serves as a clothing article accessory suited for attaching along existing drawstrings, laces, or any other wearable cord wear cord 2, shown in FIGS. 1-2. In the preferred embodiment, the aglet with an integrated whistle 1 is scaled to the size of a typical aglet to complement the overall ornamental appearance of the clothing article. In reference to FIGS. 3-7, the aglet with an integrated whistle 1 comprises an aglet body 11 and a whistle block 13. In reference to FIGS. 3-7, the aglet body 11 comprises a mouthpiece end 111, a mounting end 112, a whistle bore 113, a windway channel 114, and a whistle window 115. In the preferred embodiment, the aglet body 11 takes the form of the main chassis of the present invention that secures and constitutes the components the constitutes the present invention. In the preferred embodiment, the aglet body 11 is made out of brass but may take the form of any other suitable material, such as but not limited to stainless steel, aluminum, plastic polymers, or any other suitable material. In the preferred embodiment, the aglet body 11 is cylindrical in shape, but may take the form of any other suitable shape. In the preferred embodiment, the whistle block 13 takes the form of an airway manipulating implement, where the whistle block 13 is configured to install along the aglet body 11 in order to form the windway channel 114. In the preferred embodiment, the mouthpiece end 111 takes the form of the mouthpiece side of the aglet, where the mouthpiece end 111 of the aglet body 11 is configured as the blowing end of the aglet body 11, where a user can blow into the mouthpiece end 111 in order to produce a whistling noise. The mounting end 112 takes the form of the attachment side of the aglet, where the mounting end 112 is configured to support the attachment of the aglet body 11 to the clothes wear drawstring, lace or any other wearable cord media. In the preferred embodiment, the whistle bore 113 takes the form of the interior portion of the aglet body 11 that blown air passes through in order to produce the whistling noise when the user blows into the mouthpiece end 111. In the preferred embodiment, the windway channel 114 takes the form of the air passage formed between the whistle block 13 and the whistle bore 113. In the preferred embodiment, the windway channel 114 is configured to concentrate air blown into the windway channel 114 towards the whistle window 115 and the whistle bore 113 such that the air blown along the whistle window 115 and the whistle bore 113 produces a whistling noise. In various embodiments, the aspect ratio configuration and positioning of the whistle block 13 along the whistle bore 113 and the whistle window 115 is configured in a specified combination such that the whistling produced is suitable for a variety of applications. In one configuration, the specified combination will produce a high-pitched and loud whistling noise suitable for emergency signaling. In another configuration, the specified combination will produce a whistling noise suitable for animal calling. In the preferred embodiment the whistle window 115 takes the form of an air splitting element suitable for splitting and manipulating the blown air coming from the windway channel 114 in such a way that the split air creates a whistling noise. In reference to FIGS. 3-7, the aglet with integrated whistle as further comprises a whistle lip 116. In the preferred embodiment, the whistle lip 116 takes the form of an air-splitting implement positioned adjacent to the whistle window 115, where the whistle lip 116 is configured to split and manipulate the blown air from the windway channel 114 in order to produce a whistling noise.

The mouthpiece end 111 and the mounting end 112 are positioned terminally opposite to each other along the aglet body 11, where the mouthpiece end 111 serves as the whistle blowing end of the aglet body 11 and the mounting end 112 serves as the connection end of the aglet body 11 in order to attach the aglet body 11 to any suitable clothes wear cord 2. The whistle bore 113 traverses from the mouthpiece end 111 to the mounting end 112. The whistle window 115 is positioned between the mouthpiece end 111 and the mounting end 112. The whistle block 13 is connected within the whistle bore 113. The whistle block 13 traverses from the mouthpiece end 111 to the whistle window 115. The windway channel 114 is positioned between the whistle bore 113 and the whistle block 13. The whistle lip 116 is positioned adjacent to the whistle window 115.

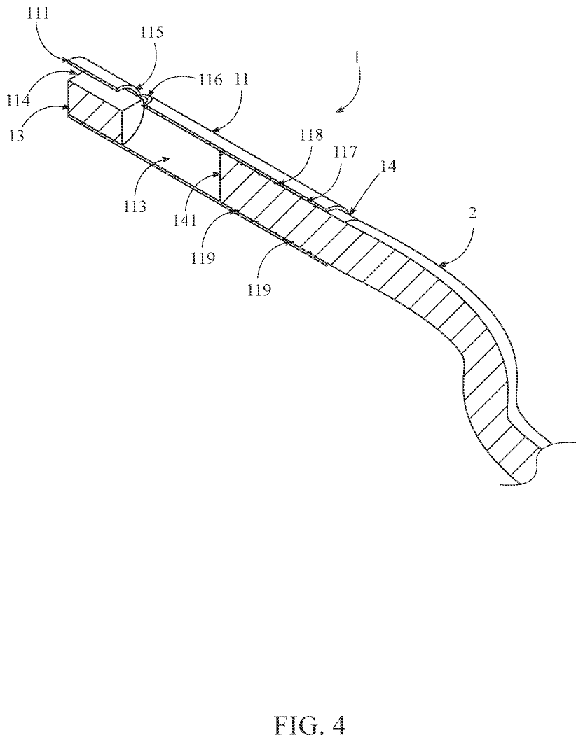

In reference to FIGS. 4-7, the aglet body 11 further comprises a mounting channel 117. In the preferred embodiment, the mounting channel 117 is configured to facilitate the attachment and mounting of the aglet body 11 to any suitable clothes wear cord 2. The mounting channel 117 traverses into the mounting end 112. In reference to FIGS. 4-7, the aglet body 11 further comprises a mounting element 118. In the preferred embodiment, the mounting element 118 takes the form of any suitable mounting implement connected along the mounting channel 117, such as, but not limited to crimp fastener implements, quick detachment fastener implements, adhesive, threaded fasteners, or any other suitable mounting element 118 that facilitates the attachment of the mounting channel 117 to any suitable clothes wear cord 2. The mounting element 118 is connected adjacent to the mounting channel 117.

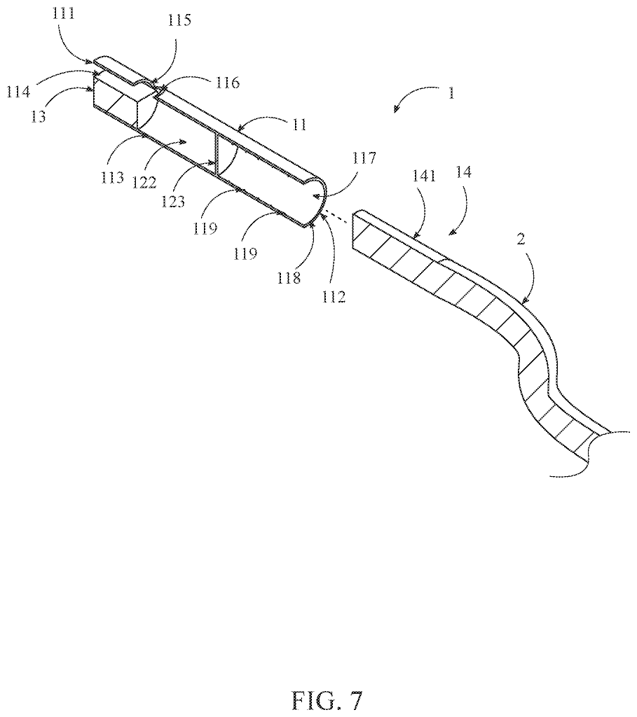

In reference to FIGS. 3-7, the aglet with integrated whistle further comprises an aglet connection element 14. In the preferred embodiment, the aglet connection element 14 installs along the end of any suitable clothes wear cord 2, where the aglet connection element 14 is configured to receive and attach along the mounting element 118 of the aglet body 11. The aglet connection element 14 is connected to the mounting element 118. In reference to FIGS. 4 and 7, the mounting element 118 comprises a plurality of crimp fastening elements 119. In the preferred embodiment, the plurality of crimp fastening elements 119 takes the form of crimp barbs that engage along the end of any suitable clothes wear cord 2 when the mounting element 118 is crimped along the end of any suitable clothes wear cord 2 using any suitable crimping tool. The plurality of crimp fastening elements 119 is distributed about the mounting channel 117. In reference to FIGS. 4 and 7, the aglet connection element 14 comprises a crimp receiving body 141. In the preferred embodiment, the crimp receiving body 141 installs along the end of any suitable clothes wear cord 2 in order to receive and support the attachment of the plurality of crimp fastening elements 119. The crimp receiving body 141 is connected along the plurality of crimp fastening elements 119.

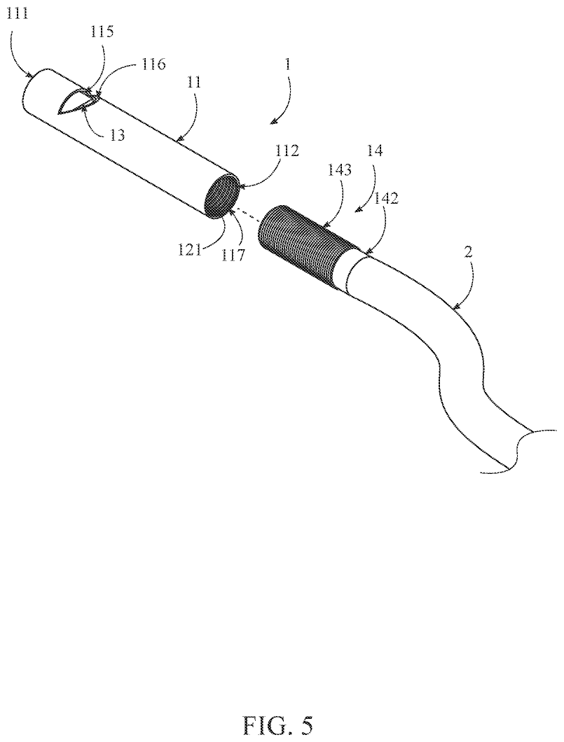

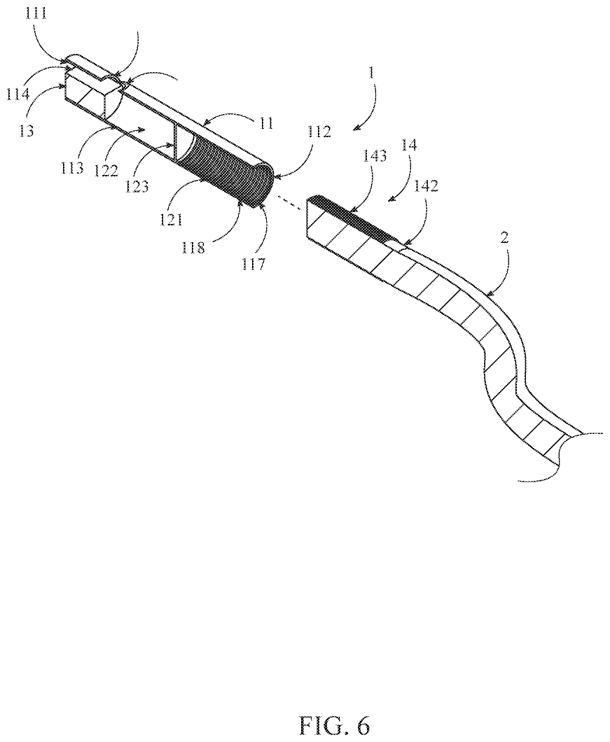

In one embodiment, the mounting element 118 comprises a first fastening thread 121, shown in FIGS. 5-6. In this embodiment, the first fastening thread 121 takes the form of screw fastener style threads that facilitate the attachment of the aglet body 11 to the aglet receiving body 142. The first fastening thread 121 traverses into the mounting end 112. In this embodiment, the aglet connection element 14 comprises an aglet receiving body 142 and a second fastening thread 143, shown in FIGS. 5-6. In the preferred embodiment, the aglet receiving body 142 takes the form of the chassis of the aglet receiving body 142 that serves as the mounting platform for the aglet body 11. The second fastening thread 143 takes the form of screw fastener style threads that facilitate the attachment of the first fastening thread 121 of the mounting element 118. The second fastening thread 143 traverses along the aglet receiving body 142. The second fastening thread 143 is removably attached along the first fastening thread 121.

In another embodiment, the aglet body 11 further comprises a whistle chamber 122 and a whistle partition 123, shown in FIGS. 6-7. In this embodiment, the whistle chamber 122 takes the form of the cavity formed between the whistle block 13 and the whistle partition 123. In this embodiment, the whistle partition 123 takes the form of a divider along the whistle bore 113 that separates the whistle chamber 122 from the mounting channel 117. In this embodiment, the whistle partition 123 serves as a length stop in order to install any suitable clothes wear cord 2 at a specified length along the mounting channel 117. The whistle partition 123 is connected within the whistle bore 113. The whistle partition 123 is connected between the whistle window 115 and the mounting end 112. The whistle chamber 122 is positioned between the whistle block 13 and the whistle partition 123.

Although the invention has been explained in relation to its preferred embodiment, it is to be understood that many other possible modifications and variations can be made without departing from the spirit and scope of the invention as hereinafter claimed.

What is claimed is:

1. An aglet with an integrated whistle comprising:
an aglet body;
a whistle block;
the aglet body comprising a mouthpiece end, a mounting end, a whistle bore, a windway channel, and a whistle window;
the mouthpiece end and the mounting end being positioned terminally opposite to each other along the aglet body;
the whistle bore traversing from the mouthpiece end to the mounting end;
the whistle window being positioned between the mouthpiece end and the mounting end;
the whistle block being connected within the whistle bore;
the whistle block traversing from the mouthpiece end to the whistle window; and
the windway channel being positioned between the whistle bore and the whistle block.

2. The aglet with integrated whistle as claimed in claim 1 comprising:
the aglet body further comprising a mounting channel; and
the mounting channel traversing into the mounting end.

3. The aglet with integrated whistle as claimed in claim 2 comprising:
the aglet body further comprising a mounting element; and
the mounting element being connected adjacent to the mounting channel.

4. The aglet with integrated whistle as claimed in claim 3 comprising:
an aglet connection element; and
the aglet connection element being connected to the mounting element.

5. The aglet with integrated whistle as claimed in claim 1 comprising:
a whistle lip; and
the whistle lip being positioned adjacent to the whistle window.

6. The aglet with integrated whistle as claimed in claim 3 comprising:
the mounting element comprising a plurality of crimp fastening elements; and
the plurality of crimp fastening elements being distributed about the mounting channel.

7. The aglet with integrated whistle as claimed in claim 6 comprising:
the aglet connection element comprising a crimp receiving body; and
the crimp receiving body being connected along the plurality of crimp fastening elements.

8. The aglet with integrated whistle as claimed in claim 3 comprising:
the mounting element comprising a first fastening thread; and
the first fastening thread traversing into the mounting end.

9. The aglet with integrated whistle as claimed in claim 4 comprising:
the aglet connection element comprising an aglet receiving body and a second fastening thread;
the second fastening thread traversing along the aglet receiving body; and
the second fastening thread being removably attached along the first fastening thread.

10. The aglet with integrated whistle as claimed in claim 1 comprising:
the aglet body comprising a whistle chamber and a whistle partition;
the whistle partition being connected within the whistle bore;
the whistle partition being connected between the whistle window and the mounting end; and
the whistle chamber being positioned between the whistle block and the whistle partition.

11. The aglet with integrated whistle as claimed in claim 1, wherein the aglet body is made out of brass.

12. An aglet with an integrated whistle comprising:
an aglet body;
a whistle block;
an aglet connection element;
the aglet body comprising a mouthpiece end, a mounting end, a whistle bore, a windway channel, a whistle window, a mounting channel, and a mounting element.
the mouthpiece end and the mounting end being positioned terminally opposite to each other along the aglet body;
the whistle bore traversing from the mouthpiece end to the mounting end;
the whistle window being positioned between the mouthpiece end and the mounting end;
the whistle block being connected within the whistle bore;
the whistle block traversing from the mouthpiece end to the whistle window;
the windway channel being positioned between the whistle bore and the whistle block;
the mounting channel traversing into the mounting end;
the mounting element being connected adjacent to the mounting channel; and
the aglet connection element being connected to the mounting element.

13. The aglet with integrated whistle as claimed in claim 12 comprising:
a whistle lip; and
the whistle lip being positioned adjacent to the whistle window.

14. The aglet with integrated whistle as claimed in claim 12 comprising:
the mounting element comprising a plurality of crimp fastening elements; and
the plurality of crimp fastening elements being distributed about the mounting channel.

15. The aglet with integrated whistle as claimed in claim 14 comprising:
the aglet connection element comprising a crimp receiving body; and
the crimp receiving body being connected along the plurality of crimp fastening elements.

16. The aglet with integrated whistle as claimed in claim 12 comprising:
the mounting element comprising a first fastening thread; and
the first fastening thread traversing into the mounting end.

17. The aglet with integrated whistle as claimed in claim 16 comprising:
the aglet connection element comprising an aglet receiving body and a second fastening thread;
the second fastening thread traversing along the aglet receiving body; and
the second fastening thread being removably attached along the first fastening thread.

18. The aglet with integrated whistle as claimed in claim 12 comprising:
the aglet body comprising a whistle chamber and a whistle partition;
the whistle partition being connected within the whistle bore;
the whistle partition being connected between the whistle window and the mounting end; and
the whistle chamber being positioned between the whistle block and the whistle partition.

19. An aglet with an integrated whistle comprising:
an aglet body;
a whistle block;
the aglet body comprising a mouthpiece end, a mounting end, a whistle bore, a windway channel, and a whistle window, a whistle chamber, and a whistle partition;
the mouthpiece end and the mounting end being positioned terminally opposite to each other along the aglet body;
the whistle bore traversing from the mouthpiece end to the mounting end;
the whistle window being positioned between the mouthpiece end and the mounting end;
the whistle block being connected within the whistle bore;
the whistle block traversing from the mouthpiece end to the whistle window;
the windway channel being positioned between the whistle bore and the whistle block;
the whistle partition being connected within the whistle bore;
the whistle partition being connected between the whistle window and the mounting end; and
the whistle chamber being positioned between the whistle block and the whistle partition.

20. The aglet with integrated whistle as claimed in claim 19 comprising:
a whistle lip; and
the whistle lip being positioned adjacent to the whistle window.
